(19) United States
(12) Patent Application Publication
(10) Pub. No.: US 2026/0117732 A1
(43) Pub. Date: Apr. 30, 2026

(54) ELECTROMAGNETIC FUEL INJECTION VALVE

(71) Applicant: HITACHI ASTEMO, LTD., HITACHINAKA-SHI, IBARAKI (JP)

(72) Inventors: Norihide OUCHI, HITACHINAKA-SHI, IBARAKI (JP); Keisuke MACHIDA, HITACHINAKA-SHI, IBARAKI (JP)

(21) Appl. No.: 18/872,522

(22) PCT Filed: Dec. 14, 2022
(86) PCT No.: PCT/JP2022/046064

§ 371 Date: Dec. 6, 2024

(51) Int. Cl. F02M 61/20; F02M 51/06

(52) U.S. Cl. CPC F02M 61/20; F02M 51/061

(57) ABSTRACT

An electromagnetic fuel injection valve (1) is provided which suppresses overshoot and overshoot return, and reduces fluid pressure acting on a valve body (6) as much as possible. In the electromagnetic fuel injection valve (1), lift of the valve body (6) to valve opening position performed against urging force of a return spring (7) in accordance with excitation of a coil is achieved by settling overshoot and overshoot return caused at that time. A small pitch part (16) of the return spring (7) exhibits a totally compressed state when lift amount of the valve body (6) is equal to or greater than a first lift amount smaller than valve opening lift amount corresponding to the valve opening position. A large pitch part (18) acts when the lift amount is equal to or greater than a second lift amount which is ½ or less of the valve opening lift amount.

### TECHNICAL FIELD

The present invention relates to an electromagnetic fuel injection valve suitable for a direct injection injector which adopts a hammering mechanism.

### BACKGROUND ART

Conventionally, in a direct injection injector employing a hammering mechanism, the lift of a valve body to a valve opening position is achieved by settling an overshoot and an overshoot return which occur during the lift (refer to, for example, Patent Literature 1),

Specifically, in the electromagnetic fuel injection valve of Patent Literature 1, when a coil is energized during a valve closed state, a movable coil is first sucked to a fixed core by a magnetic force caused due to its energization and brought into contact with a valve-opening side stopper while compressing an auxiliary spring weaker than a return spring. Thereafter, the movable core moves the valve-opening side stopper against an urging force of the return spring and collides with the fixed core to stop. During this time, the valve body is separated from a valve seat together with the valve-opening side stopper and brought into a valve open state.

However, when the movable core collides with the fixed core, the valve body and the valve-opening side stopper overshoot due to their inertia. Since the compressive deformation of the return spring is increased as the valve-opening side stopper moves away from the movable core by an amount of this overshoot, an overshoot return further occurs due to a repulsive force of the return spring. The valve body which has made the overshoot return is settled into the valve opening position by the movable core being pulled back again by the fixed core.

### CITATION LIST

### Patent Literature

Patent Literature 1: Japanese Utility Model Application Laid-Open No. S63-118376

### SUMMARY OF INVENTION

### Technical Problem

The above-described overshoot and overshoot return become factors that destabilize the operation of the valve body and increase a variation in injected fuel flow rate. Therefore, if such overshoot and overshoot return can be reduced, it is conceivable that the variation in the flow rate can be suppressed. On the other hand, when the inside of the return spring is used as a fuel passage, there is also inconvenience that fluid pressure is applied to the top of the valve body, thereby leading to a factor of reducing the maximum operating fuel pressure.

In view of the problems in the conventional technology, an object of the present invention is to suppress an overshoot and an overshoot return in an electromagnetic fuel injection valve. Another object of the present invention is to reduce fluid pressure acting on a valve body as much as possible.

### Solution to Problem

There is provided an electromagnetic fuel injection valve of the present invention which includes:
a valve housing formed with a fuel injection hole and a valve seat;
a valve body lifted from a valve closing position contacting with the valve seat to a valve opening position in accordance with excitation of a coil to enable injection of fuel from the fuel injection hole; and
a return spring which returns the valve body to the valve closing position,
and in which a lift of the valve body to the valve opening position is achieved by settling an overshoot and an overshoot return which occur upon the lift,
and which is characterized in that the return spring is an unequal pitch coil spring having a small pitch part small in pitch and a large pitch part large in pitch, and
the small pitch part exhibits a totally compressed state when a lift amount of the valve body is equal to or greater than a first lift amount smaller than a valve opening lift amount corresponding to the valve opening position, and the large pitch part acts when the lift amount of the valve body is equal to or greater than a second lift amount which is equal to or less than ½ of the valve opening lift amount.

In this configuration, when the coil is not energized, the valve body is positioned in the valve closing position by the return spring. When the coil is energized, the valve body is lifted to the valve opening position accordingly. This lift is achieved by settling the overshoot and overshoot return which occurs during the lift.

During this time, the lift amount of the valve body increases, and until it reaches the first lift amount, the small pitch part of the return spring which is small in spring constant functions to quickly increase the lift amount. When the lift amount reaches the first lift amount, the small pitch part becomes a totally compressed state and stops functioning. Further, when the lift amount reaches the second lift amount which is equal to or less than ½ of the valve opening lift amount, the large pitch part large in spring constant acts.

Therefore, by setting the first lift amount to be equal to or greater than the second lift amount, the small pitch part can be made to function until the lift amount reaches the first lift amount, and then the large pitch part can be made to function immediately. Thus, the large pitch part having a large spring constant suppresses an increase in the lift amount of the valve body before the overshoot occurs. Therefore, the overshoot and the overshoot return can be effectively suppressed.

Further, according to the present invention, when the inside of the return spring is used as a fuel passage, fuel supplied from the upstream side toward the inside of the return spring can be made to easily flow to the outside of the return spring through a large pitch interval of the large pitch part. This makes it possible to avoid fluid pressure from being applied to the top of the valve body as much as possible, and improve the maximum operating fuel pressure of the electromagnetic fuel injection valve.

In the present invention, the spring constant of the large pitch part may be several times or more that of the small pitch part. According to this, the pressing force of the large pitch part which is seven times or more that of the small pitch part, can more effectively suppress the overshoot and the overshoot return and more effectively reduce a variation in flow rate.

In the present invention, the large pitch part may be positioned on the upstream side of the return spring. According to this, the fuel supplied from the upstream side toward the inside of the return spring can be made to flow more quickly to the outside of the return spring through the large pitch interval of the large pitch part on the upstream side. Thus, since the fluid pressure applied to the valve body is more effectively reduced, the maximum operating fuel pressure of the electromagnetic fuel injection valve can be more effectively improved.

### BRIEF DESCRIPTION OF DRAWINGS

FIG. 1 is a cross-sectional view of an electromagnetic fuel injection valve according to a first embodiment of the present invention;

FIG. 2 is a cross-sectional view illustrating a state when the valve is closed, in an enlarged form of a part of FIG. 1;

FIG. 3 is a cross-sectional view illustrating a state when the valve is opened, in an enlarged form of a part of FIG. 1;

FIG. 4 is a graph illustrating the relationship between a load and a deflection in a return spring with an unequal pitch;

FIG. 5 is a graph illustrating the relationship between the number of turns and a spring constant in a return spring;

FIG. 6 is a front view illustrating a specific example of a return spring used in the electromagnetic fuel injection valve of FIG. 1;

FIG. 7A is a graph illustrating changes in the lift amount of a valve body with respect to the lapse of time when the electromagnetic fuel injection valve of FIG. 1 is in a valve open state; and

FIG. 7B is a view illustrating a part of the graph in FIG. 7A in an enlarged form.

### DESCRIPTION OF EMBODIMENTS

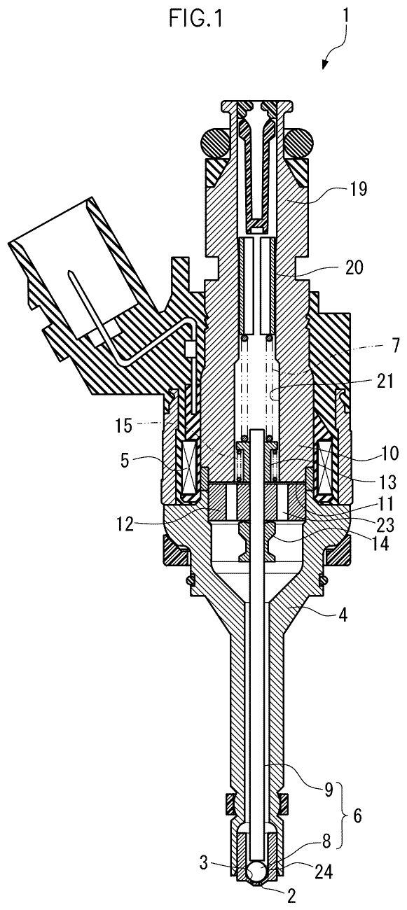

Hereinafter, embodiments of the present invention will be described with reference to the drawings. FIG. 1 illustrates an electromagnetic fuel injection valve according to one embodiment of the present invention. As illustrated in FIG. 1, this electromagnetic fuel injection valve 1 includes a valve housing 4 in which a fuel nozzle 2 (fuel injection hole) and a valve seat 3 are formed, a valve body 6 which enables fuel injection from the fuel nozzle 2 by lifting it from a valve closing position contacting with the valve seat 3 to a valve opening position according to excitation of a coil 5, and a return spring 7 which returns the valve body 6 to the valve closing position contacting with the valve seat 3.

The lift of the valve body 6 to the valve opening position is achieved by settling an overshoot and an overshoot return which occur during the lift. The valve body 6 is composed of a rod 9 connected to a valve portion 8 which cooperates with the valve seat 3.

The electromagnetic fuel injection valve 1 also includes a hollow fixed core 10 connected to an upstream end of the valve housing 4, a movable core 12 which faces a suction surface 11 of the fixed core 10 and is slidably fitted onto the rod 9, and a valve-opening side stopper 13 which is fixed to the rod 9 and comes into contact with the movable core 12 sucked to the suction surface 11 when the coil 5 is energized, thereby opening and operating the valve body 6.

A valve-closing side stopper 14 is fixed to the rod 9 on the side closer to the valve seat 3 than the valve-opening side stopper 13. There is provided between the valve-opening side stopper 13 and the movable core 12, an auxiliary spring 15 which exerts a spring force which moves the movable core 12 away from the valve-opening side stopper 13 and brings the same into contact with the valve-closing side stopper 14 when the coil 5 is deenergized.

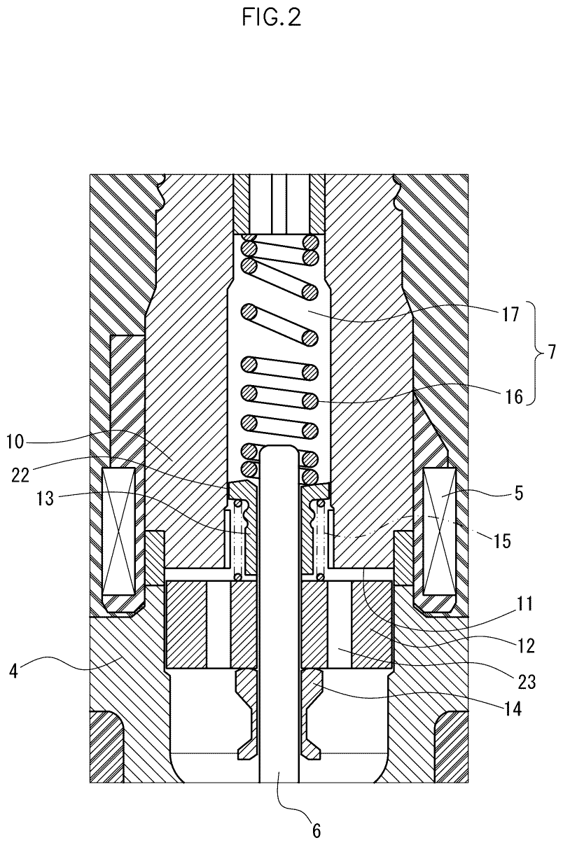

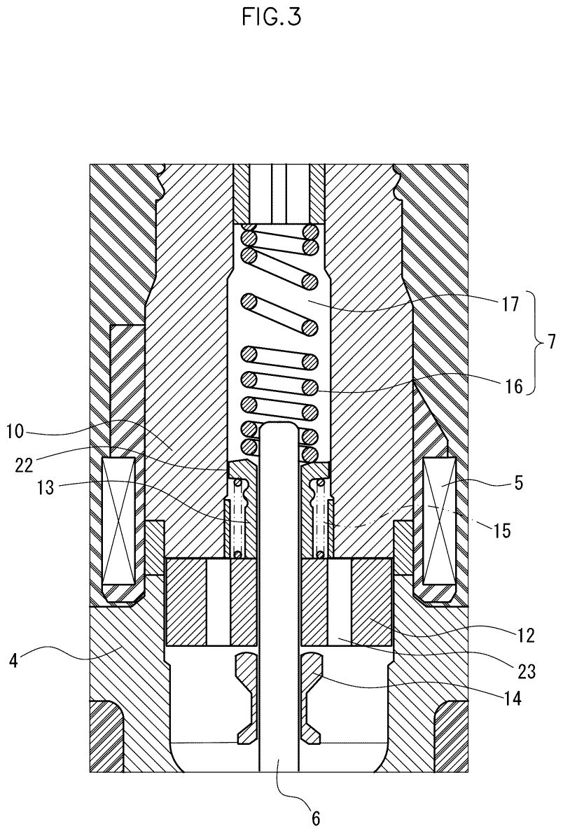

FIGS. 2 and 3 illustrate a main part of FIG. 1 in an enlarged form. FIG. 2 illustrates the manner when the valve is in a valve closed state, and FIG. 3 illustrates the manner when the valve is in a valve open state. As illustrated in FIG. 2, the return spring 7 is composed of an unequal pitch spring, and has a small pitch part 16 small in pitch and a large pitch part 17 large in pitch.

The small pitch part 16 exhibits a totally compressed state when the lift amount of the valve body 6 is equal to or greater than a first lift amount smaller than a valve opening lift amount corresponding to the valve opening position, and the large pitch part 17 acts when the lift amount is equal to or greater than a second lift amount which is equal to or less than ½ of the valve opening lift amount.

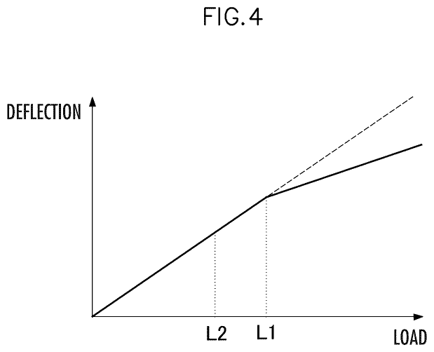

FIG. 4 illustrates the relationship between a load and a deflection in such an unequal pitch return spring 7. As illustrated by a graph curve in FIG. 4, when the load applied to the return spring 7 is equal to or less than a load L1 corresponding to the first lift amount at which the small pitch part 16 is brought into a totally compressed state, only the small pitch part 16 small in spring constant deflects, so that the amount of deflection relative to a change in the load is large.

When it is assumed that a load L2 corresponding to the second lift amount at which the large pitch part 17 functions is equal to or less than the load L1, only the large pitch part 17 large in spring constant deflects when the load exceeds the load L1 and the small pitch part 16 is brought into a totally compressed state, so that the amount of deflection relative to the change in the load becomes small. Therefore, the functions of the small pitch part 16 and the large pitch part 17 can be taken over to be used before and after the load L1.

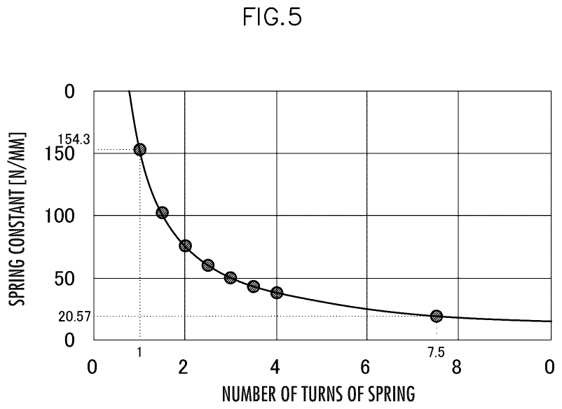

FIG. 5 illustrates the relationship between the number of turns and the spring constant in the return spring. Using this relationship, the numbers of turns in the small pitch part 16 and the large pitch part 17 can be selected to set spring constants appropriate for the small pitch part 16 and the large pitch part 17. For example, using the relationship in FIG. 5, the numbers of turns in the large pitch part 17 and the small pitch part 16 can be set so that the spring constant of the large pitch part 17 becomes seven times the spring constant of the small pitch part 16.

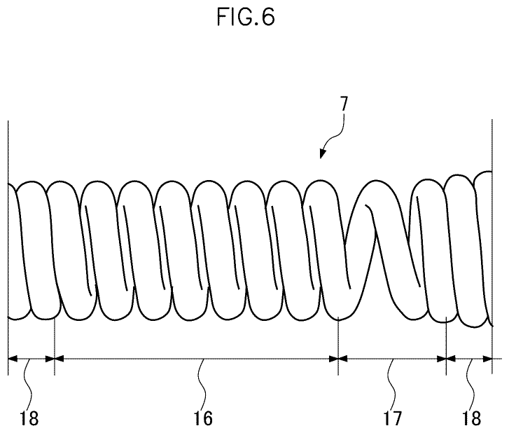

FIG. 6 illustrates a more specific example of the return spring 7 configured by selecting the numbers of turns of the small pitch part 16 and the large pitch part 17 based on the relationship between the number of turns and spring constant in FIG. 5. The small pitch part 16 of this return spring 7 is configured with 7.5 turns and has a spring constant of 20.57 N/mm and a pitch of 0.9985. The large pitch part 17 is configured with 1 turn and has a spring constant of 154.3 N/mm. Seat turns 18 on both sides of the return spring 7 are configured with 2 turns. The spring constant of the large pitch part 17 is more than seven times that of the small pitch part.

In this configuration, when the coil 5 is in a non-energized state, as illustrated in FIGS. 1 and 2, the valve body 6 is seated on the valve seat 3 by the urging force of the return spring 7, and is in a valve closed state. The movable core 12 is brought into contact with the valve-closing side stopper 14 by the urging force of the auxiliary spring 15, and maintain a predetermined gap between itself and the fixed core 10.

When the coil 5 is energized in this state, the movable core 12 is first sucked to the fixed core 10 by the resulting magnetic force and brought into contact with the valve-opening side stopper 13 while compressing the auxiliary spring 15 weaker than the return spring 7.

When the movable core 12 is brought into contact with the valve-opening side stopper 13, it quickly moves the valve-opening side stopper 13 against the urging force of the return spring 7, and collides with the suction surface 11 to stop. During this time, the rod 9 moves together with the valve-opening side stopper 13, so that the valve body 6 at the tip of the rod 9 is separated from the valve seat 3 and brought into a valve open state.

When the movable core 12 comes into contact with the suction surface 11 impactly, the valve body 6 and the valve-opening side stopper 13 overshoot due to their inertia, but the overshoot stops when the valve-closing side stopper 14 integrated with the valve body 6 collides with the movable core 12. During that time, the compressive deformation of the return spring 7 is increased while the valve-opening side stopper 13 moves away from the movable core 12 by the amount of the overshoot of the valve body 6, so that the overshoot of the valve body 6 is also suppressed by a repulsive force of the return spring 7.

When the overshoot stops, the repulsive force of the return spring 7 returns the valve-opening side stopper 13 to a position where it comes into contact with the movable core 12 which is in contact with the suction surface 11, whereby the valve body 6 is held in a predetermined valve opening position. At that time, since the urging force of the auxiliary spring 15 is smaller than the urging force of the return spring 7 which urges the valve body 6 in the valve closing direction, the auxiliary spring 15 does not interfere with the suction of the fixed core 10 to the movable core 12 and the contact of the valve-opening side stopper 13 with the movable core 12 by the return spring 7 when the coil 5 is energized, and does not inhibit the opening of the valve body 6 to a predetermined position.

Thus, during the valve opening process of the valve body 6, the impact force applied to the suction surface 11 by the movable core 12 is divided into an impact force when only the movable core 12 first collides with the suction surface 11, and an impact force when the valve-closing side stopper 14 subsequently collides with the movable core 12, so that the energy of each collision becomes relatively small, thereby making it possible to prevent wear at a contact portion between the suction surface 11 and the movable core 12 and to keep collision noise low. Further, when the valve-closing side stopper 14 collides with the movable core 12, the return spring 7 is deformed more than the amount of compressive deformation at normal valve opening, so that the return spring 7 absorbs the collision energy of the valve-closing side stopper 14 with the movable core 12 and reduces its impact force.

When the valve body 6 is opened, fuel forcibly fed from an unillustrated fuel pump to a fuel supply cylinder 19 passes successively through the inside of a pipe-shaped retainer 20, a hollow portion 21 of the fixed core 10, a flat portion 22 around the valve-opening side stopper 13, a through hole 23 of the movable core 12, the inside of the valve housing 4, and a flat portion 24 around the valve portion 8, and is directly injected from the fuel nozzle 2 into a combustion chamber of an internal combustion engine.

Next, when the energization to the coil 5 is cut off, the valve-opening side stopper 13 is pushed and moved by the repulsive force of the return spring 7 and thereby moved toward the valve seat 3 together with the movable core 12 and the valve body 6 to seat the valve portion 8 on the valve seat 3. At this time, the movable core 12 moves slightly later than when the valve portion 8 seats on the valve seat 3 due to the influence of residual magnetism between itself and the fixed core 10 and a relatively small set load of the auxiliary spring 15 which lowers the movable core 12 forward.

By the way, when the valve body 6 is first seated on the valve seat 3, it bounces back due to the impact of its seating. However, the delayed descending movable core 12 comes into contact with the valve-closing side stopper 14 fixed to the bouncing valve body 6, thereby making it possible to minimize the amount of bouncing of the valve body 6.

When the bouncing of the valve body 6 is suppressed, the valve body 6 is held in the valve closed state by the repulsive force of the return spring 7 to stop fuel injection, and the movable core 12 is held in a state in contact with the valve-closing side stopper 14 by the repulsive force of the auxiliary spring 15.

As described above, in the valve closing process of the valve body 6, the impact force exerted on the valve seat 3 by the valve body 6 is divided into the impact force when only the valve body 6 first seats on the valve seat 3 and the impact force when the movable core 12 then collides with the valve-closing side stopper 14. Therefore, the energy of each collision is relatively small. Also, when the valve body 6 first seats on the valve seat 3, it bounces off due to its seating impact, and then seats on the valve seat 3 again and gives an impact, but the valve closing stroke of the valve body 6 after bouncing off is extremely smaller than the valve closing stroke of the valve body 6 from the normal valve opening position, so that the impact force exerted on the valve seat 3 is extremely small. This can prevent wear on the mutual seating portion between the valve portion 8 and the valve seat 3, and keep the seating noise low.

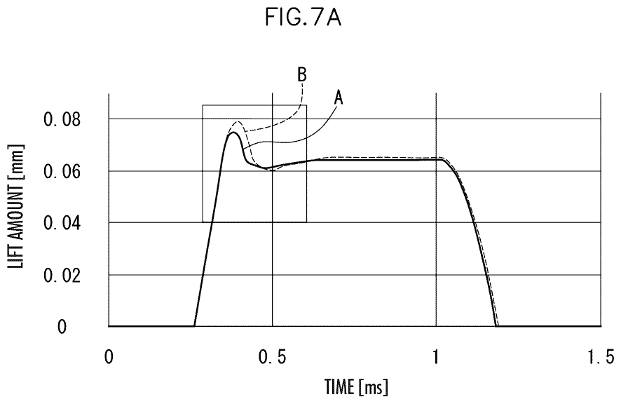

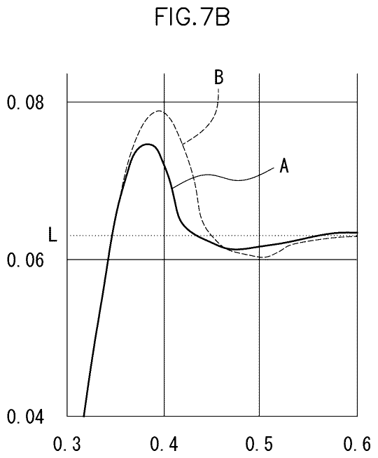

FIG. 7A illustrates changes in the lift amount of the valve body 6 with respect to the lapse of time when the electromagnetic fuel injection valve 1 is in the valve open state as described above. FIG. 7B illustrates the inside of a square frame in FIG. 7A in an enlarged form. In FIGS. 7A and 7B, the change in the lift amount when the return spring 7 of FIG. 6 in the present embodiment is used is illustrated by a graph curve A. Further, for comparison, the change in the lift amount when an equal pitch return spring constituted of 7.5 turns and having a spring constant of 20.57 N/mm and a pitch of 1.215 is used instead of the return spring 7 is illustrated by a graph curve B.

When the valve is opened, the movable core 12 collides with the valve-opening side stopper 13 according to the energization to the coil 5. After that, as illustrated in FIGS. 7A and 7B, the movable core 12 pushes up the valve-opening side stopper 13 against the urging force of the return spring 7 to increase the lift amount of the valve body 6. When the movable core 12 reaches the valve opening lift amount (valve opening position) at which the movable core 12 collides with the fixed core 10, the valve body 6 and the valve-opening side stopper 13 leave the movable core 12 due to the inertia, and move into an overshoot at which they move further upstream while taking the valve-closing side stopper 14.

However, since the return spring 7 of FIG. 6 is used in the present embodiment, the small pitch part 16 of the return spring 7 becomes a totally compressed state when the movable core 12 reaches the first lift amount before reaching the valve opening lift amount L (valve opening position; refer to FIG. 7B) at which it collides with the fixed core 10. For this reason, subsequently, the large pitch part 17 larger in spring constant acts, and due to its repulsive force, the rate of increase in the lift amount (refer to the graph curve A) falls more quickly than when the equal pitch return spring described above is used (refer to the graph curve B).

As a result, when the return spring 7 of FIG. 6 in the present embodiment is used, as illustrated by the graph curve A, an overshoot and an overshoot return are more effectively suppressed than when the return spring with the equal pitch illustrated by the graph curve B is used, and the valve opening lift amount L (valve opening position) is quickly settled.

As described above, according to the present embodiment, the large pitch part 17 effectively suppresses the overshoot and the overshoot return when the valve is opened, thereby making it possible to stabilize the operation of the valve body 6 and reduce a variation in flow rate.

Also, since the fuel supplied from the upstream side toward the inside of the return spring 7 easily flows to the outside of the return spring 7 through the large pitch interval of the large pitch part 17, it is possible to avoid fluid pressure from being applied to the top of the valve body 6 as much as possible and improve the maximum operating fuel pressure of the electromagnetic fuel injection valve 1.

Further, since the spring constant of the large pitch part 17 is more than seven times that of the small pitch part 16, it is possible to more effectively suppress an overshoot and an overshoot return by the appropriate pressing force of the large pitch part 17, and further effectively reduce a variation in flow rate.

In addition, since the large pitch part 17 is provided on the upstream side of the return spring, the fuel supplied to the inside of the return spring 7 can be made to flow to the outside of the return spring 7 more quickly. This makes it possible to more effectively reduce the fluid pressure applied to the valve body 6 and more effectively improve the maximum operating fuel pressure of the electromagnetic fuel injection valve 1.

Although the embodiment of the present invention has been described above, the present invention is not limited to this. For example, in the present embodiment, there has been adopted the hammering mechanism in which when the valve body 6 is lifted, the movable core 12 is allowed to collide with the valve-opening side stopper 13 against the urging force of the auxiliary spring 15 (hammering), and then the valve body 6 is pushed up to the valve opening side against the urging force of the return spring 7 together with the valve-opening side stopper 13. However, instead of it, the hammering may be omitted, and the valve body 6 may be directly pushed up to the valve opening side by the movable core 12 against the urging force of the return spring 7.

### Description of Reference Numerals

1: electromagnetic fuel injection valve, 2: fuel nozzle, 3: valve seat, 4: valve housing, 5: coil, 6: valve body, 7: return spring, 8: valve portion, 9: rod, 10: fixed core, 11: suction surface, 12: movable core, 13: valve-opening side stopper, 14: valve-closing side stopper, 15: auxiliary spring, 16: small pitch part, 17: large pitch part, 18: seat turns, 19: fuel supply cylinder, 20: retainer, 21: hollow portion, 22: flat portion, 23: through hole, 24: flat portion, A, B: graph curve.

1. An electromagnetic fuel injection valve comprising:
a valve housing formed with a fuel injection hole and a valve seat;
a valve body lifted from a valve closing position contacting with the valve seat to a valve opening position in accordance with excitation of a coil to enable injection of fuel from the fuel injection hole; and
a return spring which returns the valve body to the valve closing position,
the electromagnetic fuel injection valve allowing a lift of the valve body to the valve opening position to be achieved by settling an overshoot and an overshoot return which occur upon the lift,
wherein the return spring is an unequal pitch coil spring having a small pitch part small in pitch and a large pitch part large in pitch, and
wherein the small pitch part exhibits a totally compressed state when a lift amount of the valve body is equal to or greater than a first lift amount smaller than a valve opening lift amount corresponding to the valve opening position, and the large pitch part acts in a case where the lift amount of the valve body is equal to or greater than a second lift amount which is equal to or less than ½ of the valve opening lift amount.

2. The electromagnetic fuel injection valve according to claim 1, wherein a spring constant of the large pitch part is 7 times or more than a spring constant of the small pitch part.

3. The electromagnetic fuel injection valve according to claim 1, wherein the large pitch part is located on an upstream side of the return spring.
